(19) United States
(12) Patent Application Publication
(10) Pub. No.: US 2011/0302283 A1
(43) Pub. Date: Dec. 8, 2011

(54) Methods And Arrangements In A Passive Optical Network

(76) Inventor: Niclas Nors, San Jose, CA (US)

(21) Appl. No.: 12/793,130

(22) Filed: Jun. 3, 2010

(51) Int. Cl. G06F 21/20; G06F 15/177; G06F 15/16; H04J 14/00

(52) U.S. Cl. 709/222; 726/10; 709/227; 398/66

(57) ABSTRACT

Secure downloading of a certificate to an ONU (Optical Network Unit) over an ODN (Optical Distribution Network), by storing the certificate in association with an OLT (Optical Line Terminal). The OLT instructs the ONU to download a file comprising the certificate, and optionally also comprising an address to an ACS (Auto-configuration Server), and indicating the file location. Thereby, the ONU is able to fetch the file over the secure ODN, unpack the file, install the certificate, and connect to the ACS for provisioning.

### TECHNICAL FIELD

The present invention relates to methods for an OLT (Optical Line Terminal) and for an ONU (Optical Network Unit) of secure downloading of a certificate in a PON (Passive

Optical Network). The invention also relates to an OLT (Optical Line Terminal) and to an ONU (Optical Network Unit).

### BACKGROUND

Broadband access can be implemented by a fiber optical access network, e.g. a B-PON (Broadband Passive Optical Network or a G-PON (Gigabit-capable Passive Optical Network). A PON comprises an OLT (Optical Line Terminal) located at the service provider's central office and providing an interface for the delivery of the services, e.g. telephony, Ethernet data or video, over the PON. Further, the PON comprises a number of ONUs (Optical Network Units) or ONTs (Optical Network Terminations), which are connected to the OLT over an ODN (Optical Distribution Network), the ODN including optical fibers and splitters. Each ONT/ONU terminates the PON and converts the optical signals into electrical signals for delivery of the services to the end-user terminals, via a suitable user interface.

A PON does not use any electrically powered components to split the signal. Instead, the signal is distributed as encrypted or non-encrypted traffic from the OLT to the ONUs using optical beam splitters, each splitter typically splitting the signal from a single fiber into 16, 32, or 64 fibers.

The PON management protocol is standardized, as well as a management protocol called the CPE (Consumer Premises Equipment) WAN (Wireless Access Network) Management Protocol, i.e. the CWMP, initially designed for xDSL modems and gateways.

According to the standards, an ONU (Optical Network Unit) is a generic term for a device that terminates any one of the distributed (leaf) endpoints of an ODN, implements a PON protocol, and adapts PON PDU (Protocol Data Units) to subscriber service interfaces. In some contexts, an ONU implies a multiple-subscriber device. Further, an ONT (Optical Network Termination) is defined as a single subscriber device that terminates any one of the distributed (leaf) endpoints of an ODN, implements a PON protocol, and adapts PON PDUs to subscriber service interfaces. An ONT is an example of an ONU, and an ONT (Optical Network Termination) may comprise an integrated Residential Gateway

Hereinafter, the generic term ONU will be used in this specification.

In an unsecure version of the CWMP, an ONU is authenticated by a username and password. However, the secure version uses the SSL (Secure Sockets Layer), which requires that an SSL-certificate is installed in the ONU. Most operators prefer to use the secure version, to ensure that any sensitive information is encrypted, and also to ensure that the ONU is valid operator equipment.

The certificate could be used both for authentication and encryption, but the distribution of the certificate may be a problem. Since the certificate should not be downloaded over an unsecure connection, the operators normally require that the ONUs are manufactured with a pre-installed certificate for the customer. Besides the certificate, some operators may also require that the software is pre-configured with the operators ACS (Auto-Configuration Server) address. Thus, it still presents a problem to install a certificate in the ONU at a later stage, after the manufacturing, when the ONU is located at the customer premises, e.g. in a home.

### SUMMARY

The object of the present invention is to address the problem outlined above, and this object and others are achieved by the method and the arrangement according to the appended independent claims, and by the embodiments according to the dependent claims.

According to one aspect, the invention provides a method for an OLT (Optical Line Terminal) of secure downloading of a certificate to an ONU (Optical Network Unit), the certificate being stored in connection with the OLT. The method comprises:
establishing a communication channel to the ONU over a secure ODN (Optical Distribution Network);
exchanging configuration information with the ONU, the information comprising an instruction to the ONU to download a file comprising the certificate over the secure ODN, the instruction further indicating the file location.

The certificate may be stored in a certificate storage unit within the OLT, such that the file location corresponds to the location of the OLT. Alternatively, the certificate is stored in a certificate storage unit connected to the OLT via the secure ODN, such that the file location corresponds to the location of the certificate storage unit.

According to a second aspect, the invention provides a method for an ONU (Optical Network Unit) of secure downloading of a certificate, the certificate being stored in connection with an OLT (Optical Line Terminal), and the method comprises:
establishing a communication channel to the OLT over a secure ODN (Optical Distribution Network;
exchanging configuration information with the OLT, the information comprising an instruction from the OLT to download a file comprising the certificate, the instruction further indicating the file location; and
fetching the file from the file location.

Further, the certificate may be unique for each ONU.

The method may further comprise the ONU unpacking of the file and installing the certificate contained in the file, as well as the ONU establishing a connection to the ASC, using an ASC address, and exchanging configuration information with the ASC.

According to a third aspect, the invention provides an OLT (Optical Line Terminal) connectable to a secure ODN (Optical Distribution Network). The OLT is configured to download a certificate to an ONU (Optical Network Unit), and the certificate is stored in connection with the OLT. The OLT comprises the following:
a communication unit comprising a sender and a receiver for communicating over the secure ODN;
an instruction unit comprising a processing circuit. The instruction unit is configured to establish a communication channel to the ONU over the secure ODN, and exchange configuration information with the ONU, and the information comprises an instruction to the ONU to download a file comprising the certificate over the secure ODN, the instruction further indicating the file location.

The OLT may further comprise a certificate storage unit, or is alternatively connectable to a certificate storage unit over the ODN.

According to a fourth aspect, the invention provides an ONU (Optical Network Unit) connectable to a secure ODN (Optical Distribution Network). The ONU is configured to download a certificate, which is stored in connection with an OLT (Optical Line Terminal), and comprises:
a communication unit comprising a sender and a receiver for communicating over the secure ODN;
a user interface;
a downloading unit comprising a processing circuit. The downloading unit is configured to establish a communication channel to the OLT over the secure ODN; to exchange configuration information with the OLT, the information comprising an instruction from the OLT to download a file comprising the certificate, the instruction further indicating the file location; and to fetch the file from the file location.

The certificate may be unique for each ONU.

The downloading unit may be further configured to unpack the file and install the certificate contained in the file in the ONU.

The ONU may be an ONT (Optical Network Termination), comprising an Integrated Residential Gateway.

According to the above aspects, the file may further comprise the address to an ACS (Auto-Configuration Server).

It is an advantage with the invention that it allows an automatic downloading of a certificate to an ONU deployed in a secure optical network, not requiring any pre-installment, and minimizing the risk of out-of-date certificates.

### BRIEF DESCRIPTION OF THE DRAWINGS

The present invention will now be described in more detail, and with reference to the accompanying drawings, in which:

FIG. 1 is a schematic block diagram illustrating an exemplary PON.

FIG. 2 is a signalling diagram illustrating embodiments of this invention.

FIG. 3 is a flowchart illustrating exemplary methods of the invention, as performed by the OLT;

FIG. 4 is a flowchart illustrating exemplary methods of the invention, as performed by a ONU

FIG. 5 is a block diagram illustrating an OLT, according to embodiments of this invention, and

FIG. 6 is a block diagram illustrating an ONU, according to embodiments of this invention.

### DETAILED DESCRIPTION

In the following, the invention will be described in more detail with reference to certain embodiments and to accompanying drawings. For purposes of explanation and not limitation, specific details are set forth, such as particular scenarios, techniques, etc., in order to provide a thorough understanding of the present invention. However, it will be apparent to one skilled in the art that the present invention may be practised in other embodiments that depart from these specific details.

Moreover, those skilled in the art will appreciate that the functions and means explained herein below may be implemented using software functioning in conjunction with a programmed microprocessor or general purpose computer, and/or using an application specific integrated circuit (ASIC). It will also be appreciated that while the current invention is primarily described in the form of methods and devices, the invention may also be embodied in a computer program product as well as in a system comprising a computer processor and a memory coupled to the processor, wherein the memory is encoded with one or more programs that may perform the functions disclosed herein.

The basic concept of this invention is to store the certificate in the OLT, or in close connection to the OLT, and to download the certificate to the ONU over the ODN, since the ODN is a secure and trusted network.

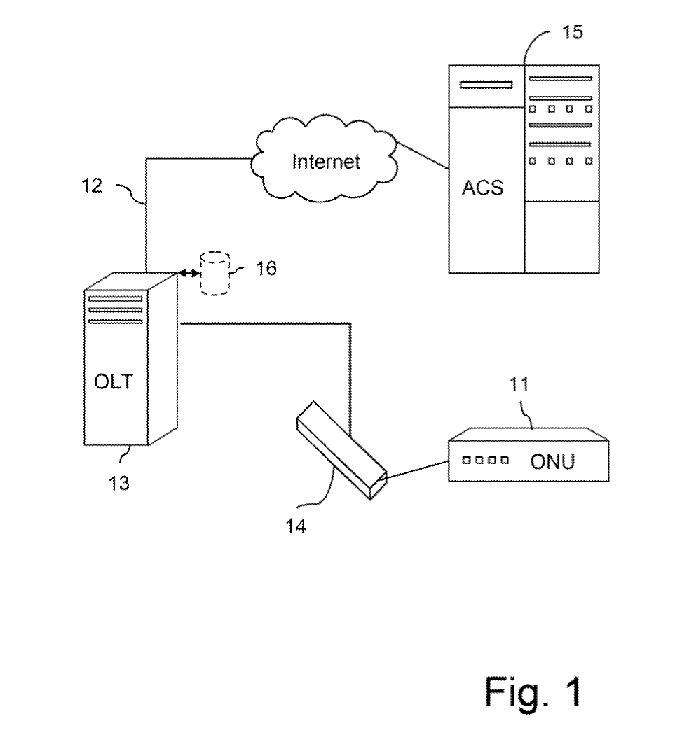

FIG. 1 illustrates schematically an exemplary PON (Passive Optical Network), comprising an ONU 11 (Optical Network Unit), an ODN 12 (Optical Distribution Network), comprising a beam splitter 14, and an OLT 13 (Optical Line Terminal), which is connected to an ACS 15 (Auto-Configuration Server) over the Internet. The ACS is able to configure, manage and provision the devices of the PON, and the ONU 11 communicates with the OLT 13 via the ODN 12. The OLT could be connected to several other ONUs, not illustrated in the figure, via the splitter 13. Further, the OLT is connected to a certificate storage server 16, which optionally could be comprised within the OLT.

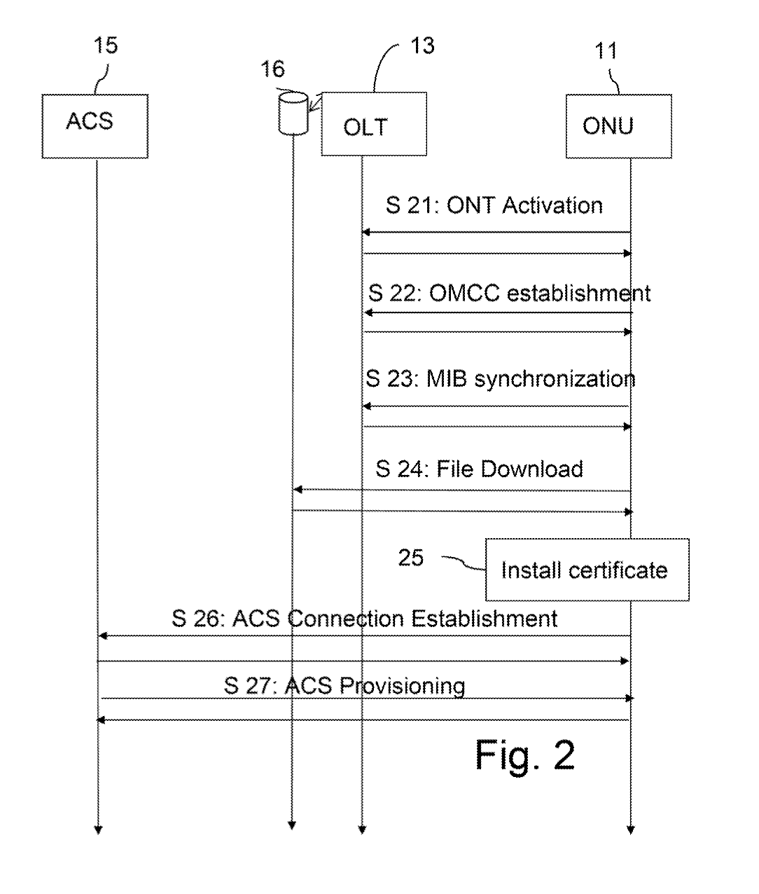

FIG. 2 is a signaling diagram schematically illustrating the connection of an ONU 11 to a PON for providing services to the end-user, the diagram also illustrating the downloading of a certificate to the ONU, according to an exemplary embodiment of the invention.

When an ONU is connected to the ODN of the PON, the ONU goes through a conventional activation process, in signal S21. The activation process typically comprises a set of distributed procedures for allowing an inactive ONU to join the PON, or to resume operations in a PON, the activation process including three phases, i.e. parameter learning, serial number acquisition and ranging.

During the parameter learning phase, the ONU remains passive, while acquiring operating parameters to be used in the upstream transmission. Next, during the serial number acquisition phase, the serial number of the new ONU is discovered by the OLT 13, and the OLT assigns an ONU-ID to the ONU. During the ranging phase, the new ONU and the OLT exchange information, e.g. regarding the optical fiber length, in order to enable transmission over a shared media.

During the above-described activation process, the ONU is authenticated, based on the ONU serial number and PLOAM password, for ensuring the identity of the ONU.

When the activation process is completed, the ONU establishes, in signal S22, an OMCC (Optical network termination Management and Control Channel) to the OLT, in order to exchange configuration data over the OMCI (Optical network termination

Management and Control Interface). During an OMCI MIB (Management Information Base)-synchronization, in signal S23, of the configuration download, the OLT instructs the ONU, e.g. via a File Transfer controller ME (Managing Entity), to download a file comprising the certificate, e.g. by using one of the following protocols: FTP (File Transfer Protocol), TFTP (Trivial File Transfer Protocol), SFTP (SSH File Transfer Protocol), HTTP (HyperText Transfer Protocol), HTTPS HyperText Transfer Protocol Secure), FLUTE (multicast, download only) or DSM-CC (Digital Storage Media Command and Control) (multicast, download only). However, a multicast download option may only be used in case the same certificate should be downloaded to every ONU, and not if the certificate is unique for a ONU.

According to this invention, the certificate is stored in connection with the OLT, i.e. in an external certificate storage server 16 connectable to the OLT over the ODN. According to an alternative exemplary embodiment, a certificate storage unit is located within the OLT. Thus, in order to enable the ONU to download the certificate, the OLT further indicates the location of the certificate, e.g. during the above described OMCI MIB synchronization.

After the OMCI MIB synchronization, the ONU fetches and downloads the file comprising the certificate, in signal S24, as instructed by the OLT via the File Transfer controller ME. According to an exemplary embodiment, the ONU also fetches a file comprising the address to an ACS (Auto-Configuration Server) 15, as well as other necessary credentials. According to other exemplary embodiments, both of these files could be put into a common file in order to simplify the transfer, since this would require only a single file downloading operation. However, according to still another exemplary embodiment, the ONU obtains the address to the ACS in some other way, e.g. via a DHCP (Dynamic Host Configuration Protocol) Option.

According to an exemplary embodiment, the file containing the certificate, and optionally the ACS address, is the same for every ONU. In this embodiment, a common certificate will be installed in several ONU:s, to be used for authentication.

However, according to another exemplary embodiment, the file containing the certificate is unique for each ONU, such that each ONU will install a unique certificate, which could be used for encryption. In this embodiment, the file may be matched to the ONU e.g. using the serial number of the ONU, or the PLOAM (Physical Layer Operations, Administration and Maintenance) password. Thereby, the OLT is able to determine which file to download to the ONU, based on the information received during the activation process, which enables a pre-provisioning and automated file download, even when the operator requires a unique file for each ONU.

After downloading the file or files, the ONU unpacks the file and installs the certificate, in step 25. When the certificate is installed, and the configuration is completed, the ONU has the necessary data and data paths to achieve connectivity with the ACS Server, e.g. over the Ethernet, as well as the necessary credentials and ACS address.

In signal S26, the ONU establishes a connection to the ACS, using the address to the ACS that may have been downloaded with certificate. When the ONU is connected to the ACS and has made its presence known, the ACS will provision the ONU, in signal S27, in particular the residential gateway part of the ONU, (if the ONU comprises a residential gateway) and download configuration data to the ONU, in order to enable the ONU to provide services to an end-user.

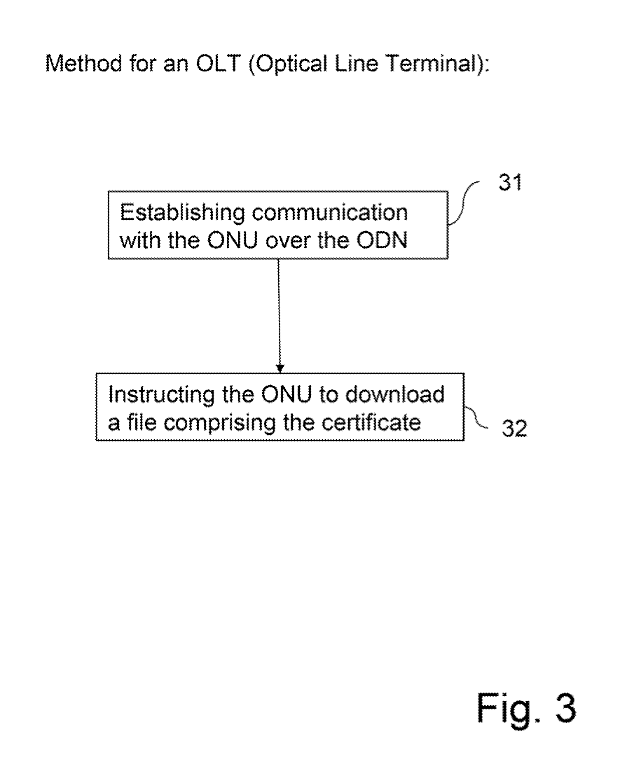

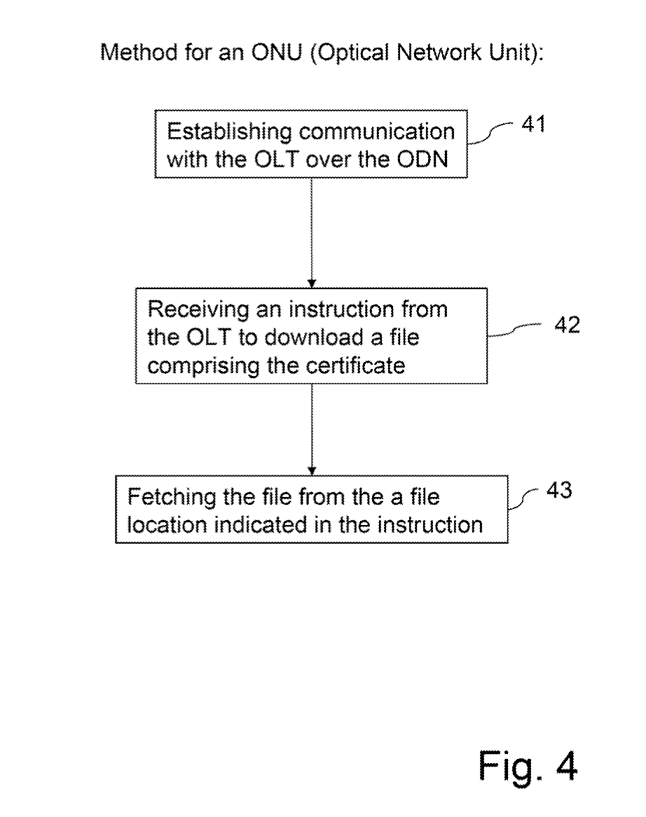

FIGS. 3 and 4 are flowcharts illustrating exemplary methods of secure downloading a certificate to an ONU, when the certificate is stored in connection with the OLT. FIG. 3 is a flowchart illustrating said methods, as performed by the OLT, and FIG. 4 is a flowchart illustrating the methods, as performed by the ONU.

In FIG. 3, the OLT (Optical Line Terminal) establishes a communication channel to the ONU (Optical Network Unit) over the ODN (Optical Distribution Network), in step 31, the ODN being a secure distribution network. According to an exemplary embodiment, this step is implemented by an OMCC establishment, as illustrated in the signal S22 in FIG. 2. Next, in step 32, the OLT exchanges configuration information with the ONU. The information comprises sending an instruction to the ONU to download a file containing the certificate over the secure ODN, and the instruction also indicates the location of the file. According to an exemplary embodiment, this step is implemented by the MIB synchronization, as illustrated in signal S23 in FIG. 2.

In FIG. 4, the ONU establishes a communication channel to the OLT over the ODN, in step 41, the ODN being a secure distribution network. According to an exemplary embodiment, this step is implemented by an OMCC establishment, as illustrated in the signal S22 in FIG. 2. Next, in step 42, the ONU exchanges configuration information with the OLT the information comprises an instruction received from the OLT to download a file containing the certificate over the secure ODN. The instruction also indicates the location of the file. According to an exemplary embodiment, this step is implemented by the MIB synchronization, as illustrated in signal S23 in FIG. 2. Next, in step 43, the ONU fetches the file comprising the certificate from the location indicated in the instruction received from the OLT. According to an exemplary embodiment, this step is implemented by the File Download, as illustrated in signal S24 in FIG. 2.

Optionally, the file could also indicate an address to an ACS (Auto-Configuration Server), in order to enable the ONU to establish connectivity with the ACS.

The certificate could be stored in a suitable file storage, i.e. a certificate storage unit 16, which could be co-located with the OLT, or connected to the OLT over the ODN. Thus, when the storage unit is co-located with the OLT, the file location corresponds to the location of the OLT.

After downloading the file comprising the certificate, the ONU unpacks the file and installs the certificate. Thereafter, the ONU is ready to connect to the ASC, using the address to the ACS, and exchange configuration information with the ASC.

According to an exemplary embodiment, the file comprising the certificate is unique for each ONU, and according to another exemplary embodiment, the same file will be fetched by several ONUs, and all the ONUs will install the same certificate.

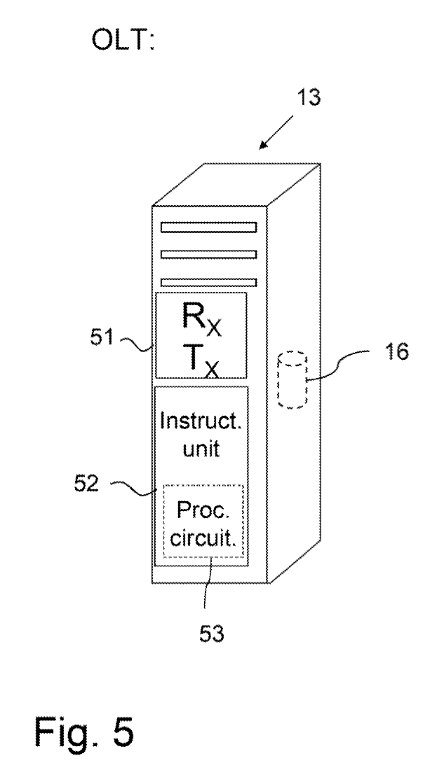

FIG. 5 illustrates schematically an exemplary OLT 13 (Optical Line Terminal), according to embodiments of this invention. A typical OLT (Optical Line Terminal) provides an interface between the services from the operator, such as e.g. telephony, data and video, and the PON, and the OLT is located at the service provider. The illustrated OLT comprises a certificate storage unit 16, for storing certificates to be downloaded to the ONU over an ODN (Optical Distribution Network), the ODN including optical fibers and splitters. However, according to an alternative embodiment (not illustrated in the figure), the OLT is connectable to an external certificate storage server.

The OLT 13 is further provided with an optical communication unit 51, comprising a sender and a receiver for communication over the ODN. The OLT also comprises an instruction unit 52 for establishing a communication channel to the ONU over the ODN and exchanging configuration information with the ONU. The information involves instructing the ONU to download a file comprising the certificate over the secure ODN, and indicating the location of the file, enabling the ONU to fetch the file at the OLT, or at the external certificate storage server 16. The instruction unit is further provided with appropriate processing circuits 53.

According to an exemplary embodiment, the OLT comprises a certificate storage unit 16, and according to another exemplary embodiment, the OLT is connectable to an external certificate storage unit 16 over the ODN.

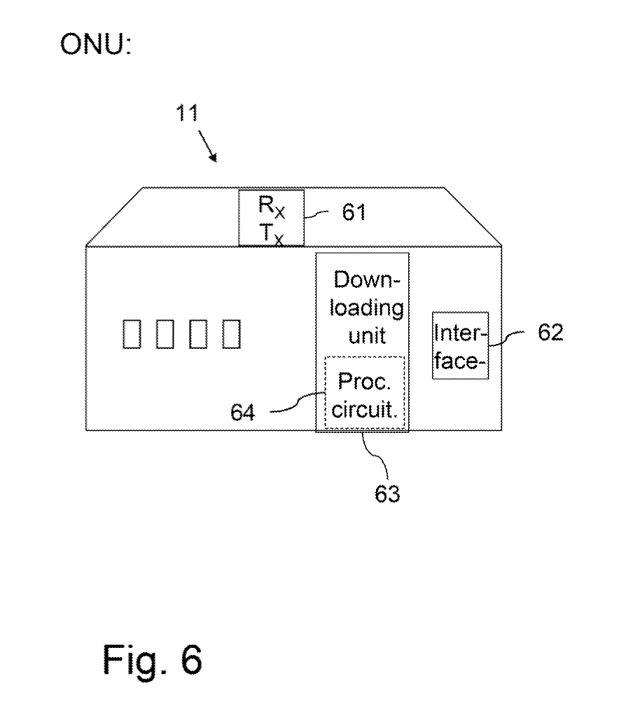

FIG. 6 illustrates schematically an exemplary ONU 11 (Optical Network Unit), ONU, according to embodiments of this invention. A typical ONU is connectable to the OLT over an ODN, and terminates the PON by converting the optical signals into electrical signals, for providing services to the end-user. Thus, the ONU is often adapted to be located at the customer premises, such as e.g. in a home of the end-user.

The ONU comprises an optical communication unit 61, comprising a sender and a receiver for communicating over the ODN. Further, the ONU comprises an interface 62 to an end-user terminal, e.g. a PC, a telephone, a video or a TV, the interface capable of converting the optical signal into electrical signals and delivering the services to the end-user terminal. The ONU also comprises a downloading unit 63 for establishing a communication channel to the OLT over the ODN, and exchanging configuration information with the OLT. The information involves an instruction received from the OLT to download a file comprising the certificate over the secure ODN, the information indicating the location of the file, thereby enabling the ONU to fetch the file at the OLT, or at the external certificate storage server 16. The downloading unit is further provided with appropriate processing circuits 64.

According to an exemplary embodiment, the downloading unit is further arranged to unpack a file, and install the certificate contained in the file.

According to an exemplary embodiment, the file comprising the certificate is unique for each ONU, and according to another exemplary embodiment, the same file will be fetched by several ONUs and all the ONUs will install the same certificate.

According to an exemplary embodiment, the ONU consists of an ONT with an integrated Residential Gateway. A typical integrated Residential Gateway is provided with functionality that may be included in advanced xDSL-modems, such as e.g. a firewall, NAT (Network Address Translator); a router, a printer server and a file server, for enabling connection to a local network, e.g. in a home. The local network may comprise e.g. several PCs and printers, and is normally connectable to the Internet

The entities and units described above with reference to FIGS. 5 and 6 are logical units, and do not necessarily correspond to separate physical units. Thus, the person skilled in the art would appreciate that the units disclosed in the FIGS. 5 and 6 may be implemented as physically integrated units, and/or physically separate units, and that the units are provided with appropriate processing circuits.

It is an advantage with the embodiments of the invention that they provide a convenient solution for certificate handling and ACS information configuration, based on existing protocols and technology, enabling implementation without any proprietary protocols or methods. Further, the manufacturer does not have to manufacture and store ONUs with a pre-installed certificate

Furthermore, the above mentioned and described embodiments are only given as examples and should not be limiting to the present invention. Other solutions, uses, objectives, and functions within the scope of the invention as claimed in the accompanying patent claims should be apparent for the person skilled in the art.

### ABBREVIATIONS

CPE Consumer Premises Equipment

ACS Auto-Configuration Server

ODN Optical Distribution Network

OLT Optical Line Terminal

OMCC Optical network termination Management and Control Channel

OMCI Optical network termination Management and Control Interface

ONT Optical Network Termination

ONU Optical Network Unit

1. A method for an Optical Line Terminal (OLT) of secure downloading of a certificate to an Optical Network Unit (ONU), wherein the certificate is stored in connection with the OLT, the method comprising:
establishing a communication channel to the ONU over a secure Optical Distribution Network (ODN);
exchanging configuration information with the ONU, the information comprising an instruction to the ONU to download a file comprising the certificate over the secure ODN, the instruction further indicating the file location.

2. The method according to claim 1, wherein the file further comprises the address to an Auto-Configuration Server (ACS).

3. The method according to claim 1, wherein the certificate is stored in a certificate storage unit within the OLT, and the file location corresponds to the location of the OLT.

4. The method according to claim 1, wherein the certificate is stored in a certificate storage unit connected to the OLT via the secure ODN, and the file location corresponds to the location of the certificate storage unit.

5. A method for an Optical Network Unit (ONU) of secure downloading of a certificate, wherein the certificate is stored in connection with an Optical Line Terminal (OLT), the method comprising:
establishing a communication channel to the OLT over a secure Optical Distribution Network (ODN);
exchanging configuration information with the OLT, the information comprising receiving an instruction from the OLT to download a file comprising the certificate, the instruction further indicating the file location; and
fetching the file from the file location.

6. The method according to claim 5, wherein the file further comprises the address of an Auto-Configuration Server (ACS).

7. The method according to claim 5, wherein the certificate is unique for the ONU.

8. The method for an ONU, according to claim 5, further comprising:
unpacking the file; and
installing the certificate contained in the file.

9. The method for an ONU, according to claim 8, further comprising:
establishing a connection to the ASC, using the ASC address; and
exchanging configuration information with the ASC.

10. An Optical Line Terminal (OLT) connectable to a secure Optical Distribution Network (ODN), the OLT configured to download a certificate to an Optical Network Unit (ONU), wherein the certificate is stored in connection with the OLT, the OLT comprising:
a communication unit comprising a sender and a receiver for communicating over the secure ODN;
an instruction unit comprising a processing circuit, the instruction unit configured to:
establish a communication channel to the ONU over the secure ODN;
exchange configuration information with the ONU, the information comprising an instruction to the ONU to download a file comprising the certificate over the secure ODN, the instruction further indicating the file location.

11. The OLT according to claim 10, wherein the file further comprises an address to an Auto-Configuration Server (ACS).

12. The OLT according to claim 10, the OLT further comprising a certificate storage unit.

13. The OLT according to claim 10, the OLT further being connectable to a certificate storage unit over the ODN.

14. An Optical Network Unit (ONU) connectable to a secure Optical Distribution Network (ODN), the ONU configured to download a certificate, which is stored in connection with an OLT (Optical Line Terminal), the ONU comprising:
a communication unit comprising a sender and a receiver for communicating over the secure ODN;
a user interface;
a downloading unit comprising a processing circuit, the downloading unit configured to:
establish a communication channel to the OLT over the secure ODN;
exchange configuration information with the OLT, the information comprising receiving an instruction from the OLT to download a file comprising the certificate, the instruction further indicating the file location; and
fetch the file from the file location.

15. The ONU according to claim 14, wherein the file further comprises an address to an Auto-Configuration Server (ACS).

16. The ONU according to claim 14, wherein the certificate is unique for the ONU.

17. The ONU according to claim 14, wherein the downloading unit is further configured to unpack the file and install the certificate contained in the file.

18. The ONU according to claim 14, the ONU being an Optical Network Termination (ONT) comprising an Integrated Residential Gateway.
